(19) United States
(12) Patent Application Publication
(10) Pub. No.: US 2025/0007431 A1
(43) Pub. Date: Jan. 2, 2025

(54) ANGLE DETECTION DEVICE, MOTOR DEVICE, AND LOGIC SIGNAL GENERATOR

(71) Applicant: TDK CORPORATION, Tokyo (JP)

(72) Inventors: Shunji SARUKI, Tokyo (JP); Hiraku HIRABAYASHI, Tokyo (JP); Kazuya WATANABE, Tokyo (JP)

(73) Assignee: TDK CORPORATION, Tokyo (JP)

(21) Appl. No.: 18/751,396

(22) Filed: Jun. 24, 2024

(30) Foreign Application Priority Data
Jun. 30, 2023 (JP) 2023-108207

(51) Int. Cl. H02P 6/16; G01B 7/30; G01D 5/16; H02K 29/08

(52) U.S. Cl. CPC H02P 6/16; G01B 7/30; G01D 5/16; H02K 29/08

(57) ABSTRACT

An angle detection device includes an angle sensor configured to detect a rotating magnetic field that changes periodically in response to a rotation angle of a motor and output a first detection signal and a second detection signal having a phase difference whose value is not an integer multiple of 90°, and a logic signal generation section configured to generate a first logic signal using the first detection signal, generate a second logic signal having a phase different from that of the first logic signal using the second detection signal, and generate a third logic signal having a phase different from those of the first and second logic signals using the first and second logic signals.

### CROSS REFERENCE TO RELATED APPLICATIONS

This application claims the benefit of Japanese Priority Patent Application No. 2023-108207 filed on Jun. 30, 2023, the entire contents of which are incorporated herein by reference.

### BACKGROUND

The technology relates to an angle detection device configured to detect the rotation angle of a motor, a motor device including a motor and the angle detection device, and a logic signal generator.

A brushless motor (also referred to as a brushless direct-current [DC] motor) uses an angle detector to detect its rotation angle. Known examples of the angle detector include a detector using a magnetic detection element such as a Hall element, and an optical detector using light. The detection signal of the angle detector is used for feedback control of the rotation angle and/or rotation speed of the brushless motor.

A brushless motor is typically a three-phase motor driven by a three-phase alternating-current voltage. A three-phase motor includes a plurality of coils controlled so that voltages are applied at respective different timings. If the three-phase motor includes three coils, the voltage application timings can be controlled using three logic signals (signals each indicating two states “high” and “low”) with 120° different phases. The detection signal of the angle detector is used to generate the three logic signals.

JP S60-134792 A discloses a driving device that generates control signals for energizing a motor's three-phase coils from a three-phase sinusoidal signal obtained from a magnetic sensing element. EP 2546611 A1 discloses that a magnetic sensor including three magnetic detection elements with 60°-shifted sensitivity axis directions and configured to output three-phase output signals is applied to rotation control of a brushless motor. U.S. Pat. No. 9,337,757 B2 discloses a motor control device that controls three-phase driving power by using an angle detection output approximate to a linear function, generated from four detection outputs obtained from outputs of two magnetic detection sections.

U.S. Pat. No. 5,945,825 A discloses a sensor device including a bridge circuit. The bridge circuit includes a pair of magnetoresistive sensor elements having bias layer portions whose magnetization directions are in parallel with a reference line and in antiparallel with each other, and another magnetoresistive sensor element having a bias layer portion whose magnetization direction forms an angle of 45° with the reference line.

To reduce the cost of a driving circuit for a brushless motor, the configuration of the driving circuit is desirably simplified. However, conventional methods have had the problem that the overall cost of the driving circuit is difficult to reduce due to the complicated configuration of the angle detector and the logic signal generator that generates a plurality of logic signals from the detection signal of the angle detector.

### SUMMARY

An angle detection device according to one embodiment of the technology is used for a driving circuit for a motor. The angle detection device according to one embodiment of the technology includes an angle sensor configured to detect a physical quantity that changes periodically in response to a rotation angle of the motor and output a first detection signal and a second detection signal having a phase difference whose value is not an integer multiple of 90°, and a logic signal generation section configured to generate a first logic signal using the first detection signal, generate a second logic signal having a phase different from that of the first logic signal using the second detection signal, and generate a third logic signal having a phase different from those of the first and second logic signals using the first and second detection signals.

A motor device according to one embodiment of the technology includes the angle detection device according to one embodiment of the technology and the motor.

A logic signal generator according to one embodiment of the technology is configured to generate three logic signals having respective different phases. The logic signal generator according to one embodiment of the technique is configured to obtain a first detection signal and a second detection signal having a phase difference whose value is not an integer multiple of 90°, generate and output a first logic signal using the first detection signal, generate and output a second logic signal having a phase different from that of the first logic signal using the second detection signal, and generate and output a third logic signal having a phase different from those of the first and second logic signals using the first and second detection signals.

In one embodiment of the technology, the first to third logic signals having respective different phases are generated using the first and second detection signals having a phase difference whose value is not an integer multiple of 90°. According to one embodiment of the technology, an angle detection device of simple configuration can thus be implemented.

Other and further objects, features and advantages of the technology will appear more fully from the following description.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is an explanatory diagram showing a configuration of a motor device according to a first example embodiment of the technology.

FIG. 2 is an explanatory diagram showing an interior of an angle detection device according to the first example embodiment of the technology.

FIG. 3 is a circuit diagram showing a circuit configuration of the angle detection device according to the first example embodiment of the technology.

FIG. 4 is an explanatory diagram showing the definitions of directions and angles in the first example embodiment of the technology.

FIG. 5 is a perspective view showing a part of a resistor section in the first example embodiment of the technology.

FIG. 6 is a waveform chart showing the waveform of each of first and second detection signals in the first example embodiment of the technology.

FIG. 7 is a timing chart showing first to third logic signals in the first example embodiment of the technology.

FIG. 8 is an explanatory diagram for describing an effect of an angle sensor in the first example embodiment of the technology.

FIG. 9 is an explanatory diagram showing a configuration of a motor device according to a second example embodiment of the technology.

FIG. 10 is a characteristic chart showing a relationship between the rotation angle of a motor and the angle of a rotating magnetic field in the second example embodiment of the technology.

FIG. 11 is a waveform chart showing the waveform of each of first and second detection signals in a comparative example.

FIG. 12 is a timing chart showing first to third logic signals of the comparative example.

FIG. 13 is a waveform chart showing the waveform of each of first and second detection signals in the second example embodiment of the technology.

FIG. 14 is a timing chart showing first to third logic signals in the second example embodiment of the technology.

FIG. 15 is an explanatory diagram showing an interior of an angle detection device according to a third example embodiment of the technology.

FIG. 16 is an explanatory diagram showing an interior of a first electronic component in a fourth example embodiment of the technology.

FIG. 17 is an explanatory diagram showing an interior of a second electronic component in the fourth example embodiment of the technology.

FIG. 18 is a circuit diagram showing a circuit configuration of an angle sensor in a fifth example embodiment of the technology.

FIG. 19 is an explanatory diagram showing a first example of a configuration of an angle detection device according to the fifth example embodiment of the technology.

FIG. 20 is an explanatory diagram showing a second example of the configuration of the angle detection device according to the fifth example embodiment of the technology.

FIG. 21 is a circuit diagram showing a circuit configuration of an angle detection device according to a sixth example embodiment of the technology.

FIG. 22 is a waveform chart showing the waveform of each of first and second detection signals in the sixth example embodiment of the technology.

FIG. 23 is a timing chart showing first to third logic signals in the sixth example embodiment of the technology.

FIG. 24 is a circuit diagram showing a circuit configuration of an angle detection device according to a seventh example embodiment of the technology.

### DETAILED DESCRIPTION

An object of the technology is to provide an angle detection device of simple configuration to be used for a driving circuit of a motor device, a motor device including the angle detection device, and a logic signal generator used for the angle detection device.

In the following, some example embodiments and modification examples of the technology are described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions. Note that the description is given in the following order.

### First Example Embodiment

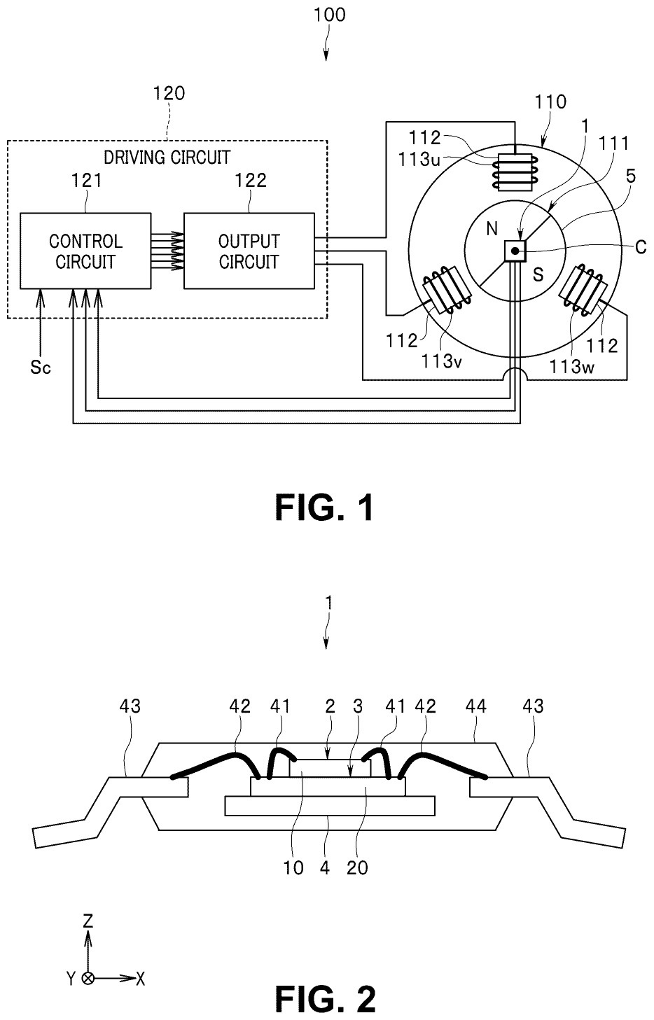

A schematic configuration of a motor device according to a first example embodiment of the technology will initially be described with reference to FIG. 1. FIG. 1 is an explanatory diagram showing a configuration of a motor device 100 according to the example embodiment.

The motor device 100 according to the example embodiment includes an angle detection device 1 according to the example embodiment, a motor 110, and a driving circuit 120 for driving the motor 110. The motor 110 is a three-phase brushless motor (also referred to as a brushless DC motor), for example. The following description will be given by using a case where the motor 110 is a three-phase brushless motor as an example. In such a case, the motor 110 includes a not-shown shaft configured to rotate about a rotation axis C, a rotor 111 fixed to the not-shown shaft, a stator 112, and a plurality of coils.

FIG. 1 shows an example where the stator 112 has three slots. In this example, the motor 110 includes a first coil 113u, a second coil 113v, and a third coil 113w as the plurality of coils. The first coil 113u, the second coil 113v, and the third coil 113w are also referred to as a U-phase coil, a V-phase coil, and a W-phase coil, respectively. The first coil 113u, the second coil 113v, and the third coil 113w are arranged about the rotation axis C at intervals of 120°.

The rotor 111 is constituted by a magnetic field generator 5 that generates a magnetic field. The magnetic field generator 5 corresponds to a “magnetic field generation section” in the technology. FIG. 1 shows a cylindrical magnet as an example of the magnetic field generator 5. This magnet is a bipolar magnet with an N pole and an S pole symmetrically arranged about an imaginary plane including the rotation axis C.

The number of slots of the stator 112 is not limited to three, and may be greater than three, like six or nine. Similarly, the number of poles of the magnetic field generator 5 is not limited to two. The magnetic field generator 5 may be a multipolar magnet such as a four-and eight-pole magnet.

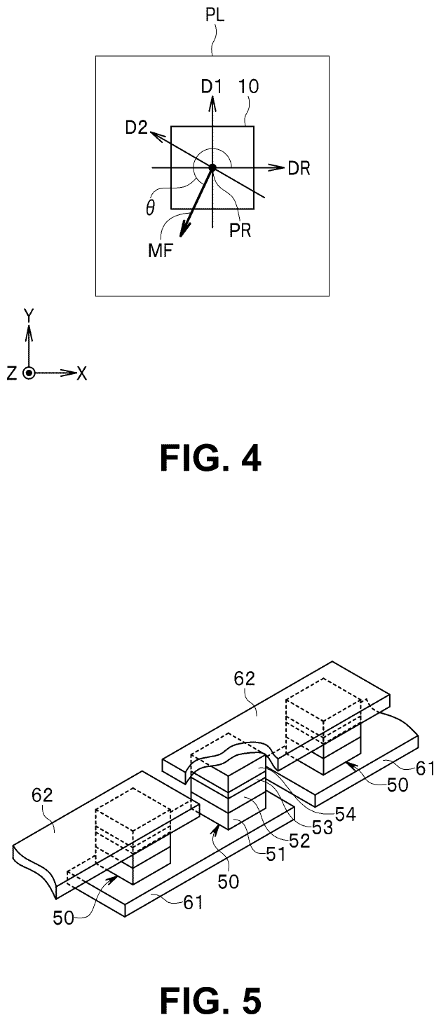

The direction of the magnetic field generated by the magnetic field generator 5 rotates with the rotation of the motor 110, i.e., the rotation of the not-shown shaft. The magnetic field generated by the magnetic field generator 5 will hereinafter be referred to as a rotating magnetic field MF. The rotating magnetic field MF is shown in FIG. 4 to be described later. The angle detection device 1 is configured to detect the rotating magnetic field MF and generate three logic signals to be used to control the timing of voltage applied to the first to third coils 113u, 113v, and 113w. In particular, in the example embodiment, the angle detection device 1 is located on the rotation axis C and opposed to an end surface of the magnetic field generator 5. The configuration of the angle detection device 1 will be described in detail later.

The driving circuit 120 includes a control circuit 121 and an output circuit 122. The control circuit 121 is configured so that the three logic signals generated by the angle detection device 1 and a speed command Sc from outside are input thereto. The control circuit 121 controls the output circuit 122 based on the three logic signals and the speed command Sc. The output circuit 122 applies voltage to each of the first to third coils 113u, 113v, and 113w based on commands from the control circuit 121.

The output circuit 122 includes not-shown six switching elements. Each of the six switching elements includes a transistor, for example. The control circuit 121 controls the six switching elements on and off and thereby controls the timing of voltage application to each of the first to third coils 113u, 113v, and 113w so that a magnetic field into which the magnetic fields generated by the first to third coils 113u, 113v, and 113w are combined (hereinafter, referred to as a composite magnetic field) rotates. The timing is controlled based on the three logic signals. The rotor 111 rotates due to the interaction of the magnetic field (rotating magnetic field MF) generated by the magnetic field generator 5 and the composite magnetic field.

The control circuit 121 compares the speed command Sc and the rotation speed of the motor 110 obtained from the three logic signals, and controls the output circuit 122 so that the rotation speed of the motor 110 follows the speed command Sc.

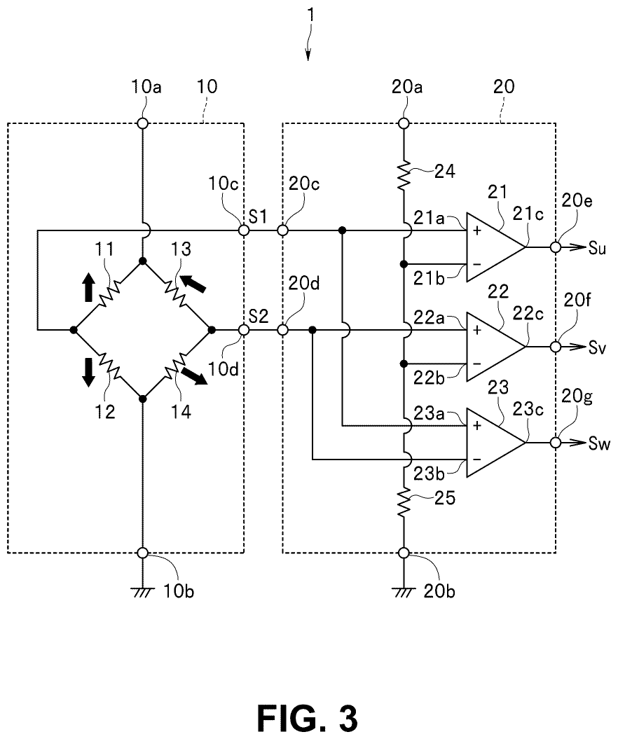

Next, the angle detection device 1 will be described in detail with reference to FIGS. 2 and 3. FIG. 2 is an explanatory diagram showing an interior of the angle detection device 1. FIG. 3 is a circuit diagram showing a circuit configuration of the angle detection device 1.

The configuration of the angle detection device 1 will initially be outlined. As described above, the angle detection device 1 is used for the driving circuit 120 for the motor 110. The angle detection device 1 includes an angle sensor 10 and a logic signal generation section 20. The angle sensor 10 and the logic signal generation section 20 may be configured as a chip of rectangular solid shape each. The chip including the angle sensor 10 will hereinafter be referred to as a first chip 2. The chip including the logic signal generation section 20 will be referred to a second chip 3. The angle detection device 1 includes the first chip 2 and the second chip 3.

As shown in FIG. 2, one of the first and second chips 2 and 3 is mounted on the other of the first and second chips 2 and 3. The angle detection device 1 further includes a substrate 4. In particular, in the example embodiment, the second chip 3 is mounted on the substrate 4, and the first chip 2 is mounted on the second chip 3.

The angle detection device 1 further includes a plurality of wires 41 connecting the first chip 2 and the second chip 3, a plurality of leads 43, a plurality of wires 42 connecting the second chip 3 and the plurality of leads 43, and a sealing resin 44 sealing the first chip 2 and the second chip 3.

Next, a configuration of the angle sensor 10 will be described. The angle sensor 10 is configured to detect a physical quantity changing periodically in response to the rotation angle of the motor 110 and output a first detection signal S1 and a second detection signal S2 having a phase difference whose value is not an integer multiple of 90°. In the example embodiment, the physical quantity is the rotating magnetic field MF generated by the magnetic field generator 5. The direction of the rotating magnetic field MF rotates with the rotation angle of the motor 110.

The definitions of directions and angles in the example embodiment will now be described with reference to FIGS. 1, 2, and 4. FIG. 4 is an explanatory diagram illustrating the definitions of the directions and angles in the example embodiment. Initially, a direction parallel to the rotation axis C shown in FIG. 1 will be defined as a Z direction. In FIG. 2, the Z direction is shown as an upward direction. As shown in FIG. 2, the first chip 2 (angle sensor 10) and the second chip 3 (logic signal generation section 20) are stacked in the Z direction. Next, two directions perpendicular to the Z direction and orthogonal to each other will be defined as an X direction and a Y direction. In FIGS. 2 and 4, the X direction is shown as a rightward direction. In FIG. 2, the Y direction is shown as a direction from the near to far side of FIG. 2. In FIG. 4, the Y direction is shown as an upward direction. The direction opposite to the X direction will be defined as a −X direction, the direction opposite to the Y direction a −Y direction, and the direction opposite to the Z direction a −Z direction.

In FIG. 4, the symbol PL denotes an imaginary plane perpendicular to the rotation axis C. This imaginary plane will hereinafter be referred to as a reference plane PL. In the example embodiment, the angle sensor 10 is configured to detect the components of the rotating magnetic field MF in directions parallel to the reference plane PL, at a reference position PR within the reference plane PL. In the following description, the direction of the rotating magnetic field MF refers to the direction within the reference plane PL. The reference position PR may be the position where the reference plane PL and the rotation axis C intersect.

In FIG. 4, the direction of the rotating magnetic field MF is indicated by the arrow denoted by the symbol MF. In the example embodiment, the direction of the rotating magnetic field MF is expressed as an angle (hereinafter, referred to as a rotating magnetic field angle) θ formed with a reference magnetic field direction DR. The reference magnetic field direction DR is the X direction. The direction of the rotating magnetic field MF rotates counterclockwise in FIG. 4. The rotating magnetic field angle θ is represented by a positive value when seen counterclockwise from the reference magnetic field direction DR, and by a negative value when seen clockwise from the reference magnetic field direction DR.

The angle sensor 10 includes a power supply terminal 10a, a ground terminal 10b, a first output terminal 10c, a second output terminal 10d, a first resistor section 11, a second resistor section 12, a third resistor section 13, a fourth resistor section 14, and a plurality of magnetic detection elements constituting the first to fourth resistor sections 11 to 14. Each of the plurality of magnetic detection elements is configured to detect the rotating magnetic field MF.

As shown in FIG. 3, the first resistor section 11 is provided between the power supply terminal 10a and the first output terminal 10c in a circuit configuration. The second resistor section 12 is provided between the ground terminal 10b and the first output terminal 10c in the circuit configuration. The third resistor section 13 is provided between the power supply terminal 10a and the second output terminal 10d in the circuit configuration. The fourth resistor section 14 is provided between the ground terminal 10b and the second output terminal 10d in the circuit configuration. In the present application, the expression “in a (the) circuit configuration” is used to indicate a layout in a circuit diagram and not a layout in a physical configuration.

A voltage or current of a predetermined magnitude is applied to the power supply terminal 10a. The ground terminal 10b is grounded.

The first output terminal 10c outputs a signal corresponding to the potential at the connection point of the first resistor section 11 and the second resistor section 12 as a first detection signal S1. The second output terminal 10d outputs a signal corresponding to the potential at the connection point of the third resistor section 13 and the fourth resistor section 14 as a second detection signal S2.

The plurality of magnetic detection elements will now be described. Each of the plurality of magnetic detection elements may be a magnetoresistive element. The magnetoresistive element may be a tunnel magnetoresistive (TMR) element, a giant magnetoresistive (GMR) element, or an anisotropic magnetoresistive (AMR) element. Alternatively, each of the plurality of magnetic detection elements may be a non-magnetoresistive element that detects a magnetic field, like a Hall element.

In the example embodiment, each of the plurality of magnetic detection elements is a spin-valve magnetoresistive element (hereinafter referred to as “MR element”). The spin-valve MR element includes a magnetization pinned layer having a first magnetization whose direction is fixed, a free layer having a second magnetization whose direction is variable depending on the rotating magnetic field MF, and a gap layer located between the magnetization pinned layer and the free layer. The spin-valve MR element may be a TMR element or a GMR element. The gap layer of the TMR element is a tunnel barrier layer. The gap layer of the GMR element is a nonmagnetic conductive layer. The spin-valve MR element varies in resistance according to the angle that the second magnetization direction of the free layer forms with the first magnetization direction of the magnetization pinned layer, and has a minimum resistance when the foregoing angle is 0° and a maximum resistance when the foregoing angle is 180°. In FIG. 3, the filled arrows indicate the magnetization directions of the magnetization pinned layers of the MR elements.

FIG. 5 is a perspective view showing a part of one of the first to fourth resistor sections 11 to 14. The resistor section includes a plurality of lower electrodes 61, a plurality of MR elements 50, and a plurality of upper electrodes 62. The plurality of lower electrodes 61 are arranged on a not-shown substrate. Each lower electrode 61 has a long slender shape. There is a gap formed between two longitudinally adjoining ones of the lower electrodes 61. As shown in FIG. 5, MR elements 50 are located near both longitudinal ends of the top surface of each lower electrode 61. Each MR element 50 includes an antiferromagnetic layer 51, a magnetization pinned layer 52, a gap layer 53, and a free layer 54 stacked in order from the lower electrode 61 side. The antiferromagnetic layer 51 is electrically connected to the lower electrode 61. The antiferromagnetic layer 51 is made of an antiferromagnetic material. The antiferromagnetic layer 51 is in exchange coupling with the magnetization pinned layer 52 and thereby fixes the magnetization direction of the magnetization pinned layer 52. The plurality of upper electrodes 62 are disposed on the plurality of MR elements 50. Each upper electrode 62 has a long slender shape, and electrically connects the free layers 54 of two adjoining MR elements 50 disposed on two longitudinally adjoining ones of the lower electrodes 61. With such a configuration, the resistor section shown in FIG. 5 includes the plurality of MR elements 50 connected in series by the plurality of lower electrodes 61 and the plurality of upper electrodes 62.

The magnetization pinned layer 52 may be a so-called self-pinned layer (Synthetic Ferri Pinned layer, SFP layer). The self-pinned layer has a stacked ferri structure in which a ferromagnetic layer, a nonmagnetic intermediate layer, and a ferromagnetic layer are stacked, and the two ferromagnetic layers are antiferromagnetically coupled. In a case where the magnetization pinned layer 52 is the self-pinned layer, the antiferromagnetic layer 51 may be omitted.

It should be appreciated that the layers 51 to 54 of each MR element 50 may be stacked in the reverse order to that shown in FIG. 5.

Next, the direction of the first magnetization of the magnetization pinned layers 52 in each of the first to fourth resistor sections 11 to 14 will be described with reference to FIGS. 3 and 4. In FIG. 4, the symbol D1 indicates a first reference direction that is a direction parallel to the sensitivity axis of each of the first and second resistor sections 11 and 12. In particular, in the example embodiment, the first reference direction D1 is a reference direction for the direction of the first magnetization of the magnetization pinned layer 52 in each of the plurality of MR elements 50 of the first and second resistor sections 11 and 12. The symbol D2 indicates a second reference direction that is a direction parallel to the sensitivity axis of each of the third and fourth resistor sections 13 and 14. In particular, in the example embodiment, the second reference direction D2 is a reference direction for the direction of the first magnetization of the magnetization pinned layer 52 in each of the plurality of MR elements 50 of the third and fourth resistor sections 13 and 14.

In the example embodiment, the first reference direction D1 and the second reference direction D2 satisfy the following first requirement: The direction of the rotating magnetic field MF detected by each of the plurality of MR elements 50 of the first and second resistor sections 11 and 12 at a predetermined timing when the rotating magnetic field MF changes periodically will be referred to as a first magnetic field direction. The direction of the rotating magnetic field MF detected by each of the plurality of MR elements 50 of the third and fourth resistor sections 13 and 14 at the same predetermined timing will be referred to as a second magnetic field direction. The first requirement is that a difference between an angle that the first magnetic field direction forms with the first reference direction D1 and an angle that the second magnetic field direction forms with the second reference direction D2 be an angle that is not an integer multiple of 90°.

In the example embodiment, the first reference direction D1 and the second reference direction D2 further satisfy the following second requirement: The second requirement is that an angle formed between the first reference direction D1 and the second reference direction D2 not be an integer multiple of 90°.

In particular, in the example embodiment, the first reference direction D1 is the Y direction. The second reference direction D2 is a direction 60° rotated from the Y direction (first reference direction D1) to the-X direction. In such a case, the difference between the angle that the first magnetic field direction forms with the first reference direction D1 and the angle that the second magnetic field direction forms with the second reference direction D2 is 60°. The angle formed between the first reference direction D1 and the second reference direction D2 is also 60°.

The first magnetization of the magnetization pinned layer 52 in each of the plurality of MR elements 50 of the first resistor section 11 includes a component in the first reference direction D1 (Y direction). The first magnetization of the magnetization pinned layer 52 in each of the plurality of MR elements 50 of the second resistor section 12 includes a component in the opposite direction (−Y direction) from the first reference direction D1.

The first magnetization of the magnetization pinned layer 52 in each of the plurality of MR elements 50 of the third resistor section 13 includes a component in the second reference direction D2. The first magnetization of the magnetization pinned layer 52 in each of the plurality of MR elements 50 of the fourth resistor section 14 includes a component in the opposite direction from the second reference direction D2.

If the first magnetization of the magnetization pinned layer 52 includes a component in a specific reference direction, the component in the specific reference direction may be the main component of the first magnetization of the magnetization pinned layer 52. Alternatively, the first magnetization of the magnetization pinned layer 52 may be free of a component in a direction orthogonal to the specific reference direction. In the example embodiment, if the first magnetization of the magnetization pinned layer 52 includes a component in the specific reference direction, the direction of the first magnetization of the magnetization pinned layer 52 is the same or substantially the same as the specific reference direction.

Next, the first detection signal S1 and the second detection signal S2 will be described. In the angle sensor 10, the potential at the connection point of the first resistor section 11 and the second resistor section 12 changes with the strength of a component (hereinafter, referred to as first component) of the rotating magnetic field MF in a direction parallel to the first reference direction D1. The angle sensor 10 thus detects the strength of the first component and outputs a signal indicating the strength as the first detection signal S1. The first detection signal S1 has a correspondence with the strength of the first component. The strength of the first component has a correspondence with the rotating magnetic field angle θ (see FIG. 4). The strength of the first component may be represented by a positive value if the direction of the first component is the same as the first reference direction D1, and a negative value if the direction of the first component is the same as the direction opposite to the first reference direction D1.

In the angle sensor 10, the potential at the connection point of the third resistor section 13 and the fourth resistor section 14 changes with the strength of a component (hereinafter, referred to as second component) of the rotating magnetic field MF in a direction parallel to the second reference direction D2. The angle sensor 10 thus detects the strength of the second component and outputs a signal indicating the strength as the second detection signal S2. The second detection signal S2 has a correspondence with the strength of the second component. The strength of the second component has a correspondence with the rotating magnetic field angle θ (see FIG. 4). The strength of the second component may be represented by a positive value if the direction of the second component is the same as the second reference direction D2, and a negative value if the direction of the second component is the same as the direction opposite to the second reference direction D2.

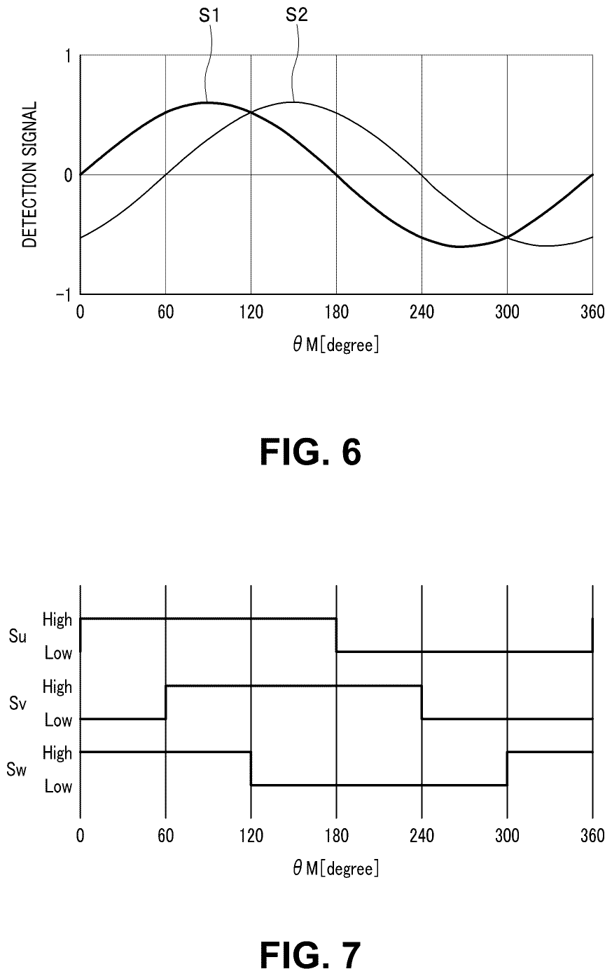

FIG. 6 is a waveform chart showing the waveform of each of the first and second detection signals S1 and S2. In FIG. 6, the horizontal axis indicates a rotation angle OM of the motor 110, and the vertical axis indicates the magnitude of the signals.

The vertical axis is in arbitrary unit. In the example embodiment, the value of the rotation angle OM is the same or substantially the same as that of the rotating magnetic field angle θ.

As shown in FIG. 6, in the example embodiment, the phase difference between the first detection signal S1 and the second detection signal S2 is 60°. In other words, in the example embodiment, the angle formed between the first reference direction D1 and the second reference direction D2 is the same as the angle corresponding to the phase difference between the first detection signal S1 and the second detection signal S2.

Next, a configuration of the logic signal generation section 20 will be described. The logic signal generation section 20 is configured to obtain the first detection signal S1 and the second detection signal S2, generate and output a first logic signal Su using the first detection signal S1, generate and output a second logic signal Sv having a phase different from that of the first logic signal Su using the second detection signal S2, and generate and output a third logic signal Sw having a phase different from those of the first and second logic signals Su and Sv using the first and second detection signals S1 and S2.

The logic signal generation section 20 can be implemented by an application-specific integrated circuit (ASIC), for example. The logic signal generation section 20 that can be configured as a chip, like the logic signal generation section 20 implemented by an ASIC, is also referred to as a “logic signal generator” in particular.

The logic signal generation section 20 includes a power supply terminal 20a, a ground terminal 20b, a first input terminal 20c, a second input terminal 20d, a first output terminal 20e, a second output terminal 20f, a third output terminal 20g, a first comparator 21, a second comparator 22, a third comparator 23, and two resistors 24 and 25. The first comparator 21 includes a first input port 21a, a second input port 21b, and an output port 21c. The second comparator 22 includes a first input port 22a, a second input port 22b, and an output port 22c. The third comparator 23 includes a first input port 23a, a second input port 23b, and an output port 23c.

An end of the resistor 24 is connected to the power supply terminal 20a. An end of the resistor 25 is connected to the other end of the resistor 24. The other end of the resistor 25 is connected to the ground terminal 20b. A voltage of a predetermined magnitude is applied to the power supply terminal 20a. The ground terminal 20b is grounded.

The first input port 21a of the first comparator 21 and the first input port 23a of the third comparator 23 are connected to the first input terminal 20c. The first input port 22a of the second comparator 22 and the second input port 23b of the third comparator 23 are connected to the second input terminal 20d. The second input port 21b of the first comparator 21 and the second input port 22b of the second comparator 22 are connected to the connection point of the resistors 24 and 25.

The first output terminal 10c of the angle sensor 10 is connected to the first input terminal 20c of the logic signal generation section 20. The first output terminal 10c is thus connected to the first input port 21a of the first comparator 21 and the first input port 23a of the third comparator 23 via the first input terminal 20c. The second output terminal 10d of the angle sensor 10 is connected to the second input terminal 20d of the logic signal generation section 20. The second output terminal 10d is connected to the first input port 22a of the second comparator 22 and the second input port 23b of the third comparator 23 via the second input terminal 20d.

The output port 21c of the first comparator 21 is connected to the first output terminal 20e. The first output terminal 20e outputs the signal output from the output port 21c of the first comparator 21 as the first logic signal Su.

The output port 22c of the second comparator 22 is connected to the second output terminal 20f. The second output terminal 20f outputs the signal output from the output port 22c of the second comparator 22 as the second logic signal Sv.

The output port 23c of the third comparator 23 is connected to the third output terminal 20g. The third output terminal 20g outputs the signal output from the output port 23c of the third comparator 23 as the third logic signal Sw.

Next, the first to third logic signals Su, Sv, and Sw will be described with reference to FIGS. 6 and 7. FIG. 7 is a timing chart showing the first to third logic signals Su, Sv, and Sw.

The first logic signal Su will initially be described. The first detection signal S1 is input to the first input port 21a of the first comparator 21. A reference voltage with a magnitude corresponding to a value of 0 on the vertical axis of FIG. 6 is input to the second input port 21b of the first comparator 21. The first comparator 21 compares the value of the first detection signal S1 with that of the reference voltage, and outputs the first logic signal Su. As shown in FIG. 6, the value of the first detection signal S1 is greater than that of the reference voltage (0 on the vertical axis of FIG. 6) if the rotation angle θM is greater than 0° and less than 180°. The value of the first detection signal S1 is less than that of the reference voltage (0 on the vertical axis of FIG. 6) if the rotation angle θM is greater than 180° and less than 360°. The first comparator 21 thus outputs a high-level signal if the rotation angle θM is greater than 0° and less than 180°, and outputs a low-level signal if the rotation angle θM is greater than 180° and less than 360°.

Next, the second logic signal Sv will be described. The second detection signal S2 is input to the first input port 22a of the second comparator 22. The reference voltage with the magnitude corresponding to the value of 0 on the vertical axis of FIG. 6 is input to the second input port 22b of the second comparator 22. The second comparator 22 compares the value of the second detection signal S2 with that of the reference voltage, and outputs the second logic signal Sv. As shown in FIG. 6, the value of the second detection signal S2 is greater than that of the reference voltage (0 on the vertical axis of FIG. 6) if the rotation angle θM is greater than 60° and less than 240°. The value of the second detection signal S2 is less than that of the reference voltage (0 on the vertical axis of FIG. 6) if the rotation angle θM is greater than or equal to 0° and less than 60°, or greater than 240° and less than or equal to 360°. The second comparator 22 thus outputs a high-level signal if the rotation angle θM is greater than 60° and less than 240°, and outputs a low-level signal if the rotation angle θM is greater than or equal to 0° and less than 60°, or greater than 240° and less than or equal to 360°.

Next, the third logic signal Sw will be described. The first detection signal S1 is input to the first input port 23a of the third comparator 23. The second detection signal S2 is input to the second input port 23b of the third comparator 23. The third comparator 23 compares the value of the first detection signal S1 with the value of the second detection signal S2, and outputs the third logic signal Sw. As shown in FIG. 6, the value of the first detection signal S1 is greater than that of the second detection signal S2 if the rotation angle θM is greater than or equal to 0° and less than 120°, or greater than 300° and less than or equal to 360°. The value of the first detection signal S1 is less than that of the second detection signal S2 if the rotation angle θM is greater than 120° and less than 300°. The third comparator 23 thus outputs a high-level signal if the rotation angle θM is greater than or equal to 0° and less than 120°, or greater than 300° and less than or equal to 360°, and outputs a low-level signal if the rotation angle θM is greater than 120° and less than 300°.

In the example embodiment, the control circuit 121 detects the rotation angle θM using the first to third logic signals Su, Sv, and Sw. Specifically, when the first to third logic signals Su, Sv, and Sw are at the high level, low level, and high level, respectively, the control circuit 121 determines that the rotation angle θM is in the range of 0° to 60°. When the first to third logic signals Su, Sv, and Sw are at the high level, high level, and high level, respectively, the control circuit 121 determines that the rotation angle θM is in the range of 60° to 120°. In such a manner, the control circuit 121 detects the rotation angle θM in units of 60° (every ⅙ turns) depending on the combination of the levels of the first to third logic signals Su, Sv, and Sw.

In the example embodiment, the phase difference between the first logic signal Su and the second logic signal Sv is 60°. The phase difference between the first logic signal Su and the third logic signal Sw is 60°. The phase difference between the second logic signal Sv and the third logic signal Sw is 120°.

Next, a method for manufacturing the angle sensor 10 will be briefly described. The method for manufacturing the angle sensor 10 includes the step of forming the plurality of MR elements 50, the step of forming the power supply terminal 10a, the ground terminal 10b, the first output terminal 10c, and the second output terminal 10d, and the step of forming a plurality of pieces of wiring connecting the plurality of MR elements 50 with the power supply terminal 10a, the ground terminal 10b, the first output terminal 10c, and the second output terminal 10d.

In the step of forming the plurality of the first MR elements 50, a plurality of initial MR elements to later become the plurality of MR elements 50 are initially formed. Each of the plurality of initial MR elements includes at least an initial magnetization pinned layer to later become the magnetization pinned layer 52, and the free layer 54 and the gap layer 53.

Next, the magnetization directions of the initial magnetization pinned layers are fixed to predetermined directions using laser light and external magnetic fields in the foregoing predetermined directions. For example, the plurality of initial MR elements to later become the plurality of MR elements 50 of the first resistor section 11 are irradiated with the laser light while an external magnetic field in the first reference direction D1 (Y direction) is applied thereto. When the laser light irradiation is completed, the magnetization directions of the initial magnetization pinned layers are fixed to the first reference direction D1. The initial magnetization pinned layers thereby become the magnetization pinned layers 52, and the plurality of initial MR elements become the plurality of MR elements 50 of the first resistor section 11.

For another plurality of initial MR elements to later become the plurality of MR elements 50 of the second resistor section 12, the direction of the external magnetic field is set to the direction opposite to the first reference direction D1 (−Y direction). The magnetization direction of the initial magnetization pinned layer in each of the other plurality of initial MR elements can thereby be fixed to the direction opposite to the first reference direction D1. In such a manner, the plurality of MR elements 50 of the second resistor section 12 are formed.

Similarly, for another plurality of initial MR elements to later become the plurality of MR elements 50 of the third resistor section 13, the direction of the external magnetic field is set to the second reference direction D2. The magnetization direction of the initial magnetization pinned layer in each of the other plurality of initial MR elements can thereby be fixed to the second reference direction D2. In such a manner, the plurality of MR elements 50 of the third resistor section 13 are formed.

Similarly, for the other plurality of initial MR elements to later become the plurality of MR elements 50 of the fourth resistor section 14, the direction of the external magnetic field is set to the direction opposite to the second reference direction D2. The magnetization direction of the initial magnetization pinned layer in each of the other plurality of initial MR elements can thereby be fixed to the direction opposite to the second reference direction D2. In such a manner, the plurality of MR elements 50 of the fourth resistor section 14 are formed.

Next, the operation and effects of the angle detection device 1 according to the example embodiment will be described. In the example embodiment, the angle sensor 10 generates the first and second detection signals S1 and S2 to generate the first to third logic signals Su, Sv, and Sw. According to the example embodiment, the configuration of the angle sensor 10 can thereby be simplified compared to the case where three detection signals with respective difference phases are generated to generate the three logic signals. For example, according to the example embodiment, magnetic detection elements whose sensitivity axis is in a direction intersecting both the first and second reference directions D1 and D2 can be omitted.

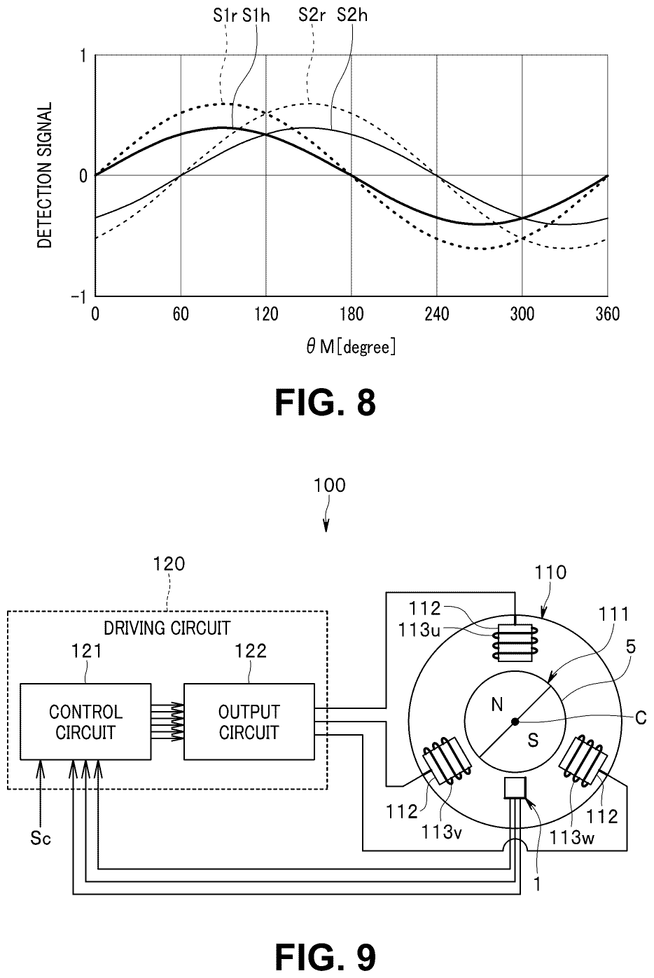

Now, if Hall elements are used as the magnetic detection elements, a temperature sensor is needed to compensate for variations in the output characteristics of the Hall elements due to temperature. By contrast, if the MR elements 50 are used as the magnetic detection elements, the temperature sensor can be omitted. This effect will now be described with reference to FIG. 8.

FIG. 8 is an explanatory diagram (waveform chart) for describing the effect of the angle sensor 10. In FIG. 8, the horizontal axis indicates the rotation angle θM of the motor 110, and the vertical axis indicates the magnitude of the signals. The vertical axis is in an arbitrary unit. In FIG. 8, the curve denoted by the symbol S1r represents the waveform of the first detection signal S1 at room temperature. The curve denoted by the symbol S1h represents the waveform of the first detection signal S1 at high temperature. The curve denoted by the symbol S2r represents the waveform of the second detection signal S2 at room temperature. The curve denoted by the symbol S2h represents the waveform of the second detection signal S2 at high temperature.

As can be seen from FIG. 8, the amplitudes of the first and second detection signals S1 and S2 vary as the temperature changes. However, the phases of the first and second detection signals S1 and S2 do not vary even when the temperature changes. The timing for each of the first to third logic signals Su, Sv, and Sw to switch between the high and low levels therefore does not vary, and the detection result of the rotation angle θM of the motor 110 does not vary, either. Since the detection result of the rotation angle θM of the motor 110 does not vary even when the temperature changes, the temperature sensor can be omitted if the MR elements 50 are used as the magnetic detection elements.

In the example embodiment, the angle sensor 10 can be formed in a single chip by forming the plurality of MR elements 50 using the laser light and the external magnetic fields of predetermined directions as described above. This can also simplify the configuration of the angle sensor 10.

### Second Example Embodiment

Next, a second example embodiment of the technology will be described. Initially, a schematic configuration of a motor device according to the second example embodiment of the technology will be described with reference to FIG. 9. FIG. 9 is an explanatory diagram showing the configuration of the motor device according to the example embodiment.

In the example embodiment, the angle detection device 1 is located away from the rotation axis C. For example, the angle detection device 1 is located outside the outer periphery of the magnetic field generator 5. As described in the first example embodiment, the angle sensor 10 is configured to detect the components of the rotating magnetic field MF in directions parallel to the reference plane PL, at the reference position PR within the reference plane PL (see FIG. 4). In the present example embodiment, the reference position PR is located away from the rotation axis C (for example, at a position where the angle detection device 1 is located).

In the example embodiment, at least one of the first and second reference directions D1 and D2 is different from that in the first example embodiment. In other respects, the configuration of the motor device 100 according to the example embodiment is the same as that of the first example embodiment.

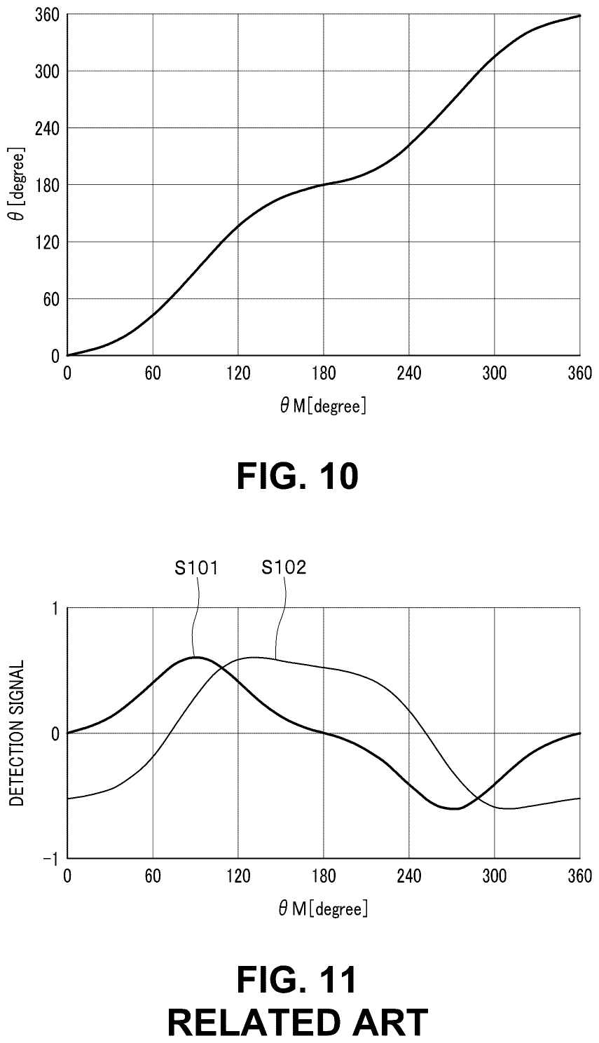

Next, the reason why at least one of the first and second reference directions D1 and D2 is different from that in the first example embodiment will be described. FIG. 10 is a characteristic chart showing a relationship between the rotation angle θM of the motor 110 and the rotating magnetic field angle θ. In FIG. 10, the horizontal axis indicates the rotation angle θM, and the vertical axis indicates the rotating magnetic field angle θ. Ideally, the value of the rotating magnetic field angle θ that the direction of the rotating magnetic field MF forms with the reference magnetic field direction DR is the same as the rotation angle θM. However, in the example embodiment, the value of the rotating magnetic field angle θ deviates from that of the rotation angle θM, and the amount of deviation in the value of the rotating magnetic field angle θ varies depending on the value of the rotation angle θM. The reason is that at the reference position PR in the example embodiment, the waveform indicating a change in the strength of a component of the rotating magnetic field MF in one direction (hereinafter, referred to as a magnetic field strength waveform) is distorted from a sinusoidal curve.

Suppose that an angle detection device of a comparative example is located at the same position as that of the angle detection device 1 according to the example embodiment. The angle detection device of the comparative example includes an angle sensor of the comparative example and a logic signal generation section of the comparative example. The angle sensor of the comparative example has the same configuration as that of the angle sensor 10 in the first example embodiment, including both the first and second reference directions D1 and D2, i.e., the direction of the first magnetization of the magnetization pinned layer 52 in each of the plurality of MR elements 50. The angle sensor of the comparative example is configured to output a first detection signal S101 and a second detection signal S102 corresponding to the first detection signal S1 and the second detection signal S2, respectively.

The logic signal generation section of the comparative example has the same configuration as that of the logic signal generation section 20 according to the first example embodiment. The logic signal generation section of the comparative example is configured to generate first to third logic signals Su, Sv, and Sw of the comparative example based on the first and second detection signals S101 and S102.

FIG. 11 is a waveform chart showing the waveform of each of the first and second detection signals S101 and S102 according to the comparative example. In FIG. 11, the horizontal axis indicates the rotation angle θM of the motor 110, and the vertical axis indicates the magnitude of the signals. The vertical axis is in an arbitrary unit.

The first detection signal S101 has a correspondence with the strength of the component of the rotating magnetic field MF in the direction parallel to the Y direction (the same direction as the first reference direction D1 in the first example embodiment) at the reference position PR. The second detection signal S102 has a correspondence with the strength of the component of the rotating magnetic field MF in a direction parallel to a direction 60° rotated from the Y direction to the-X direction (the same direction as the second reference direction D2 in the first example embodiment) at the reference position PR. As described above, the magnetic field strength waveform is distorted from a sinusoidal curve. The waveform of each of the first and second detection signals S101 and S102 is therefore also distorted from a sinusoidal curve.

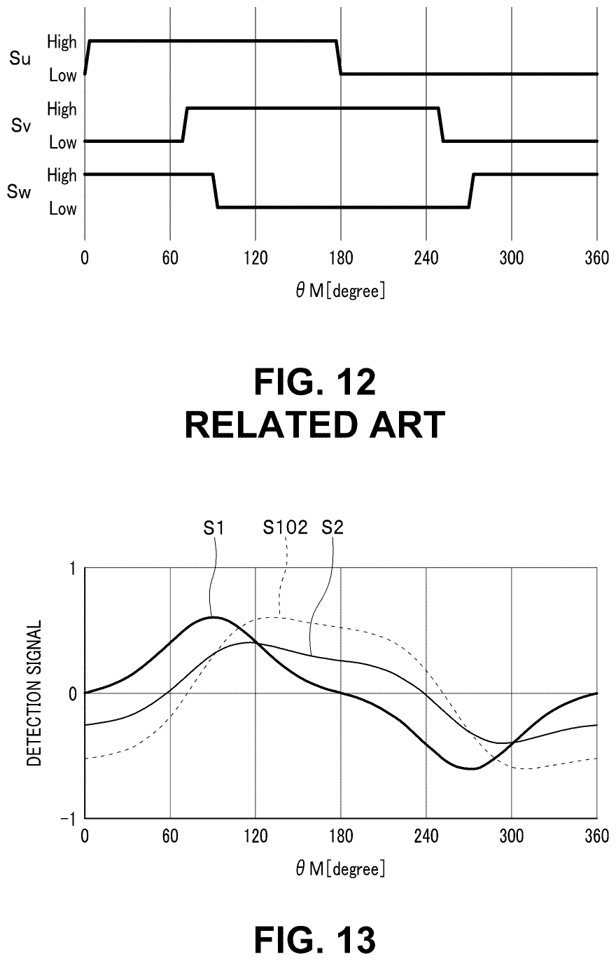

FIG. 12 is a timing chart showing the first to third logic signals Su, Sv, and Sw of the comparative example. In the comparative example, the timing (rotation angles θM) at which the second logic signal Sv switches between the high and low levels differs from that shown in FIG. 7 in the first example embodiment. Similarly, in the comparative example, the timing (rotation angles θM) at which the third logic signal Sw switches between the high and low levels differs from that shown in FIG. 7 in the first example embodiment.

As described above, in the comparative example, the timing at which each of the second and third logic signals Sv and Sw switches between the high and low levels differs from that in the first example embodiment. The reason is that the waveform of each of the first and second detection signals S101 and S102 is distorted from a sinusoidal curve. The timing (rotation angles θM) at which the waveforms of the first and second detection signals S101 and S102 intersect therefore differs from the timing at which the waveforms of the first and second detection signals S1 and S2 shown in FIG. 6 in the first example embodiment intersect. As a result, the timing at which each of the second and third logic signals Sv and Sw switches between the high and low levels deviates from that in the first example embodiment.

The timing at which the first logic signal Su switches between the high and low levels is substantially the same as the timing shown in FIG. 7 in the first example embodiment. The reason is that the phase of the first detection signal S1 and that of the first detection signal S101 are aligned for the sake of comparison.

As can be seen from FIG. 12, in the comparative example, the rotation angle θM is unable to be detected in units of 60° (every ⅙ turns). By contrast, in the example embodiment, the phase and amplitude of at least one of the first and second detection signals S1 and S2 are adjusted so that the rotation angle θM can be detected in units of 60° (every ⅙ turns).

In the example embodiment, the phase of at least one of the first and second detection signals S1 and S2 is adjusted by making at least one of the first and second reference directions D1 and D2 different from that in the first example embodiment. The case of adjusting the phase and amplitude of the second detection signal S2 will now be described as an example.

The phase of the second detection signal S2 can be adjusted by adjusting the second reference direction D2 serving as a reference for the direction of the first magnetization of the magnetization pinned layer 52 in each of the plurality of MR elements 50 of the third and fourth resistor sections 13 and 14. In the example embodiment, the second reference direction D2 is a direction rotated from the Y direction (first reference direction D1) to the-X direction by an angle greater than 60°, or from the Y direction to the-X direction by an angle less than 60°. The amplitude of the second detection signal S2 can be adjusted using an amplifier, for example. The amplifier may be included in the angle sensor 10 or the logic signal generation section 20.

In the example embodiment, the phase and amplitude of the second detection signal S2 are adjusted so that the waveform of the first detection signal S1 and that of the second detection signal S2 intersect at the same timing (rotation angles θM) as in the first example embodiment. The timing at which each of the first to third logic signals Su, Sv, and Sw switches between the high and low levels can thereby be made the same as in the first example embodiment.

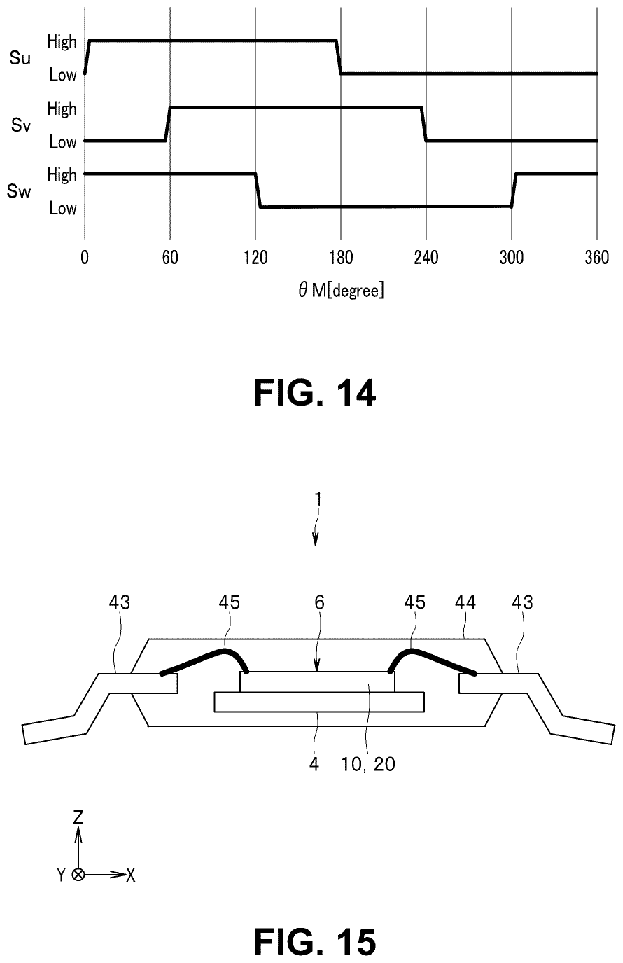

FIG. 13 is a waveform chart showing the waveform of each of the first and second detection signals S1 and S2 in the example embodiment. In FIG. 13, the horizontal axis indicates the rotation angle θM of the motor 110, and the vertical axis indicates the magnitude of the signals. The vertical axis is in an arbitrary unit. The waveform of the first detection signal S1 shown in FIG. 13 is the same as that of the first detection signal S101 of the comparative example shown in FIG. 11. FIG. 13 also shows the waveform of the second detection signal S102 of the comparative example shown in FIG. 11. The second detection signal S102 substantially corresponds to the second detection signal S2 before the phase and amplitude adjustment.

As shown in FIG. 13, in the example embodiment, the second detection signal S2 is adjusted so that the waveform of the first detection signal S1 and that of the second detection signal S2 intersect at rotation angles θM of 120° and 300°. In the example embodiment, the angle formed between the first reference direction D1 and the second reference direction D2 is different from the angle corresponding to the phase difference between the first detection signal S1 and the second detection signal S2.

FIG. 14 is a timing chart showing the first to third logic signals Su, Sv, and Sw. As shown in FIG. 14, the timing at which each of the first to third logic signals Su, Sv, and Sw switches between the high and low levels is substantially the same as the timing shown in FIG. 7 in the first example embodiment. According to the example embodiment, the rotation angle θM can thus be detected in units of 60° (every ⅙ turns).

In the example embodiment, the phase and amplitude of the first detection signal S1 may be adjusted instead of adjusting the phase and amplitude of the second detection signal S2. Alternatively, the phases and amplitudes of both the first and second detection signals S1 and S2 may be adjusted.

As has been described, in the example embodiment, the direction of at least one of the first and second reference directions D1 and D2 is made different from that in the first example embodiment to enable the detection of the rotation angle θM in units of 60° (every ⅙ turns).

The configuration, operation and effects of the present example embodiment are otherwise the same as those of the first example embodiment.

### Third Example Embodiment

Next, a third example embodiment of the technology will be described with reference to FIG. 15. FIG. 15 is an explanatory diagram showing an interior of an angle detection device according to the example embodiment.

An angle detection device 1 according to the example embodiment includes a chip 6 of rectangular solid shape instead of the first and second chips 2 and 3 in the first example embodiment. The chip 6 is mounted on the substrate 4. The chip 6 includes the angle sensor 10 and the logic signal generation section 20. In the chip 6, either the angle sensor 10 or the logic signal generation section 20 may be stacked on the other of the angle sensor 10 and the logic signal generation section 20. Alternatively, the angle sensor 10 and the logic signal generation section 20 may be located at respective different positions in a direction parallel to the XY plane.

The angle detection device 1 according to the example embodiment also includes a plurality of wires 45 connecting the chip 6 and the plurality of leads 43 instead of the plurality of wires 41 and the plurality of wires 42 in the first example embodiment.

The configuration, operation and effects of the present example embodiment are otherwise the same as those of the first or second example embodiment.

### Fourth Example Embodiment

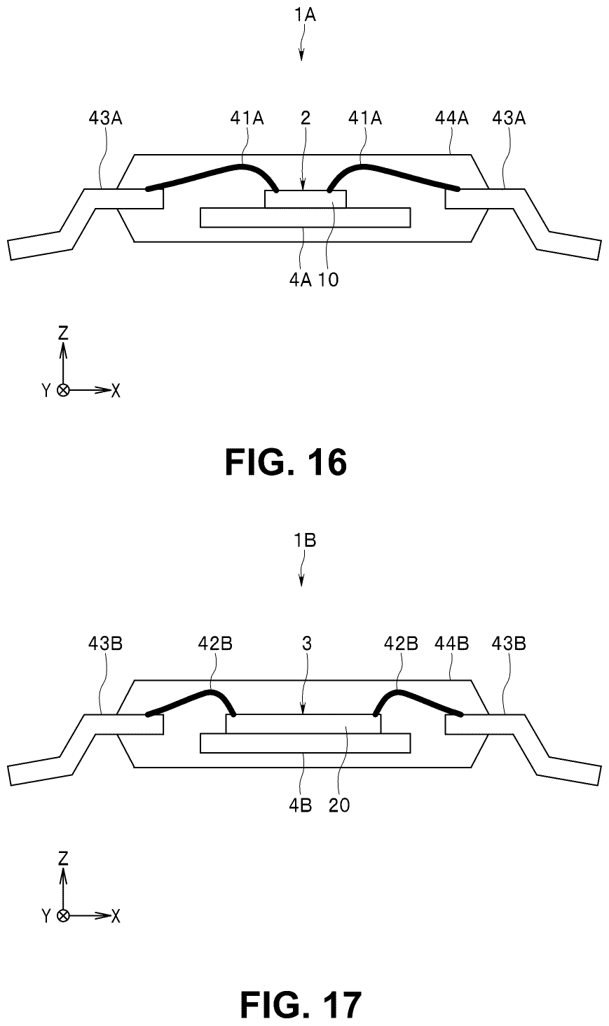

Next, a fourth example embodiment of the technology will be described with reference to FIGS. 16 and 17. FIG. 16 is an explanatory diagram showing an interior of a first electronic component in the example embodiment. FIG. 17 is an explanatory diagram showing an interior of a second electronic component in the example embodiment.

An angle detection device 1 according to the example embodiment includes a first electronic component 1A and a second electronic component 1B instead of the substrate 4, the plurality of wires 41, the plurality of wires 42, the plurality of leads 43, and the sealing resin 44 in the first example embodiment. The first electronic component 1A includes the first chip 2 including the angle sensor 10. The second electronic component 1B includes the second chip 3 including the logic signal generation section 20.

The first electronic component 1A further includes a substrate 4A on which the first chip 2 (angle sensor 10) is mounted, a plurality of leads 43A, a plurality of wires 41A connecting the first chip 2 and the plurality of leads 43A, and a sealing resin 44A sealing the first chip 2.

The second electronic component 1B further includes a substrate 4B on which the second chip 3 (logic signal generation section 20) is mounted, a plurality of leads 43B, a plurality of wires 42B connecting the second chip 3 and the plurality of leads 43B, and a sealing resin 44B sealing the second chip 3.

The first electronic component 1A may be located at the same position as the angle detection device 1 according to the first example embodiment, or at the same position as the angle detection device 1 according to the second example embodiment. The second electronic component 1B may be located near the first electronic component 1A or away from the first electronic component 1A.

The configuration, operation and effects of the present example embodiment are otherwise the same as those of the first or second example embodiment.

### Fifth Example Embodiment

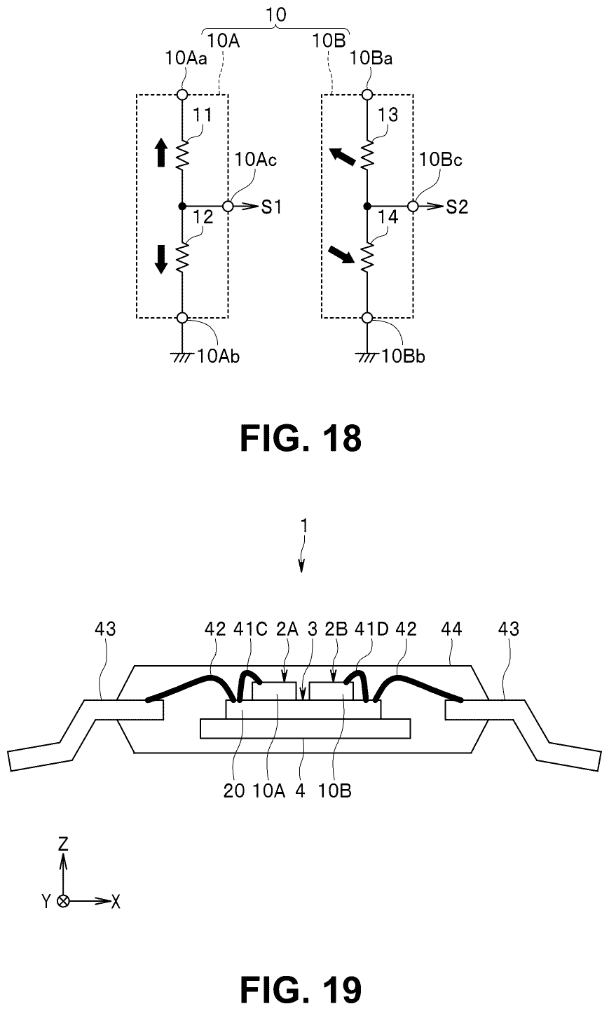

Next, a fifth example embodiment of the technology will be described. A configuration of an angle sensor 10 in the example embodiment will initially be described with reference to FIG. 18. FIG. 18 is a circuit diagram showing a circuit configuration of the angle sensor 10 in the example embodiment.

The angle sensor 10 in the example embodiment includes a first detection circuit 10A and a second detection circuit 10B. The first detection circuit 10A includes a power supply terminal 10Aa, a ground terminal 10Ab, a first output terminal 10Ac, a first resistor section 11, and a second resistor section 12. Each of the first and second resistor sections 11 and 12 has the same configuration as in the first example embodiment.

The first resistor section 11 is provided between the power supply terminal 10Aa and the first output terminal 10Ac in the circuit configuration. The second resistor section 12 is provided between the ground terminal 10Ab and the first output terminal 10Ac in the circuit configuration. A voltage or current of a predetermined magnitude is applied to the power supply terminal 10Aa. The ground terminal 10Ab is grounded. The first output terminal 10Ac outputs a signal corresponding to the potential at the connection point of the first resistor section 11 and the second resistor section 12 as a first detection signal S1.

The second detection circuit 10B includes a power supply terminal 10Ba, a ground terminal 10Bb, a second output terminal 10Bc, a third resistor section 13, and a fourth resistor section 14. Each of the third and fourth resistor sections 13 and 14 has the same configuration as in the first example embodiment.

The third resistor section 13 is provided between the power supply terminal 10Ba and the second output terminal 10Bc in the circuit configuration. The fourth resistor section 14 is provided between the ground terminal 10Bb and the second output terminal 10Bc in the circuit configuration. A voltage or current of a predetermined magnitude is applied to the power supply terminal 10Ba. The ground terminal 10Bb is grounded. The second output terminal 10Bc outputs a signal corresponding to the potential at the connection point of the third resistor section 13 and the fourth resistor section 14 as a second detection signal S2.

The first output terminal 10Ac of the first detection circuit 10A is connected to the first input terminal 20c (see FIG. 3) of the logic signal generation section 20. The second output terminal 10Bc of the second detection circuit 10B is connected to the second input terminal 20d (see FIG. 3) of the logic signal generation section 20.

Next, a first example and a second example of the configuration of the angle detection device 1 according to the example embodiment will be described. The first example will initially be described with reference to FIG. 19. FIG. 19 is an explanatory diagram showing the first example of the configuration of the angle detection device 1. In the first example, the angle detection device 1 includes chips 2A and 2B of rectangular solid shape instead of the first chip 2 in the first example embodiment. The chips 2A and 2B are both mounted on the second chip 3 (logic signal generation section 20). The chip 2A includes the first detection circuit 10A. The chip 2B includes the second detection device 10B.

In the first example, the angle detection device 1 includes a plurality of wires 41C connecting the chip 2A and the second chip 3 and a plurality of wires 41D connecting the chip 2B and the second chip 3 instead of the plurality of wires 41 in the first example embodiment.

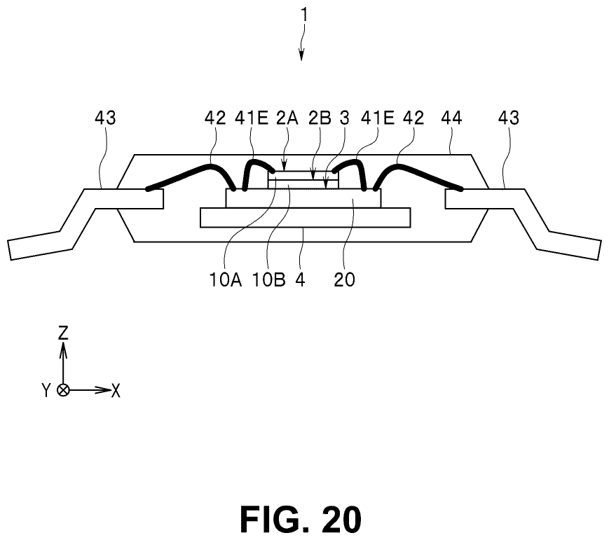

Next, the second example will be described with reference to FIG. 20. FIG. 20 is an explanatory diagram showing the second example of the configuration of the angle detection device 1. In the second example, like the first example, the angle detection device 1 includes the chips 2A and 2B. In particular, in the second example, the chips 2A and 2B are stacked on the second chip 3 (logic signal generation section 20). In the example shown in FIG. 20, the chip 2B is mounted on the second chip 3. The chip 2A is mounted on the chip 2B.

In the second example, the angle detection device 1 includes a plurality of wires 41E connecting the chip 2A and the second chip 3 instead of the plurality of wires 41 in the first example embodiment. The second detection circuit 10B in the chip 2B may be connected to the logic signal generation section 20 in the second chip 3 via the chip 2A and the plurality of wires 41E. Alternatively, the second detection circuit 10B in the chip 2B may be connected to the logic signal generation section 20 in the second chip 3 without the intervention of the chip 2A or the plurality of wires 41E.

The configuration, operation and effects of the present example embodiment are otherwise the same as those of the first or second example embodiment.

### Sixth Example Embodiment

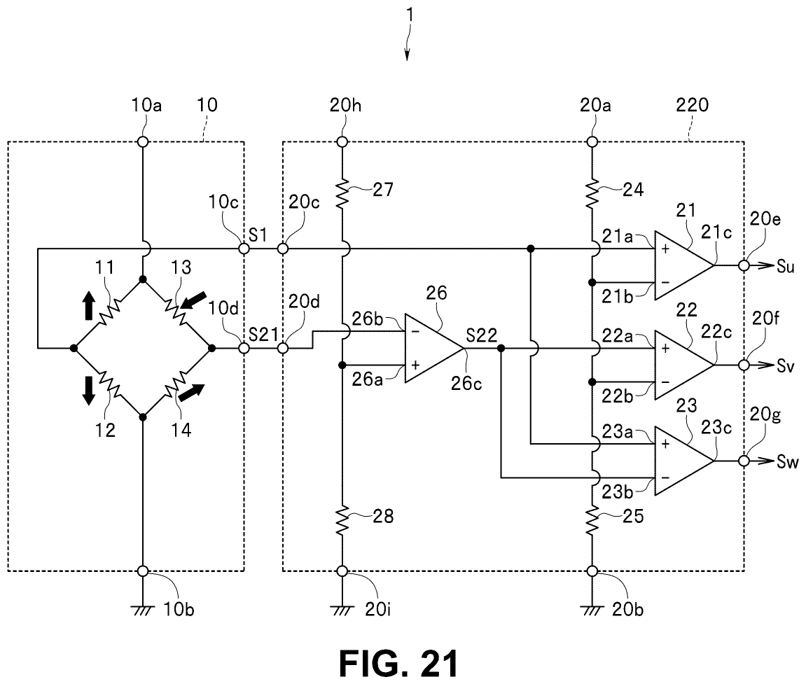

Next, a sixth example embodiment of the technology will be described. Initially, a configuration of an angle detection device 1 according to the example embodiment will be described with reference to FIG. 21. FIG. 21 is a circuit diagram showing a circuit configuration of the angle detection device 1.

In the example embodiment, the second reference direction D2 (see FIG. 4) is different from that in the first example embodiment. As described in the first example embodiment, the second reference direction D2 is a reference direction for the direction of the first magnetization of the magnetization pinned layer 52 in each of the plurality of MR elements 50 of the third and fourth resistor sections 13 and 14 of the angle sensor 10. In the example embodiment, the second reference direction D2 is a direction 30° rotated from the −X direction to the −Y direction. An angle formed between the first reference direction D1 (Y direction) and the second reference direction D2 is 120°.

In the example embodiment, the angle sensor 10 is configured to output a second detection signal S21 instead of the second detection signal S2 in the first example embodiment. The second detection signal S21 is a signal corresponding to the potential at the connection point of the third resistor section 13 and the fourth resistor section 14, and is output from the second output terminal 10d of the angle sensor 10. The second detection signal S21 has a correspondence with the strength of the component of the rotating magnetic field MF in a direction parallel to the second reference direction D2. A phase difference between the first detection signal S1 and the second detection signal S21 is 120°.

In the example embodiment, the logic signal generation section 20 includes another power supply terminal 20h, another ground terminal 20i, an inverting amplifier 26, and resistors 27 and 28. The inverting amplifier 26 includes a first input port 26a, a second input port 26b, and an output port 26c.

An end of the resistor 27 is connected to the power supply terminal 20h. An end of the resistor 28 is connected to the other end of the resistor 27. The other end of the resistor 28 is connected to the ground terminal 20i. A voltage of a predetermined magnitude is applied to the power supply terminal 20h. The ground terminal 20i is grounded.

The first input port 26a of the inverting amplifier 26 is connected to the connection point of the resistor 27 and the resistor 28. The second input port 26b of the inverting amplifier 26 is connected to the second input terminal 20d of the logic signal generation section 20.

In the example embodiment, the first input port 22a of the second comparator 22 and the second input port 23b of the third comparator 23 are connected to the output port 26c of the inverting amplifier 26 instead of the second input terminal 20d.

The inverting amplifier 26 is configured to output a signal obtained by inverting the phase of the second detection signal S21 by 180°. The signal obtained by inverting the phase of the second detection signal S21 by 180° will hereinafter be referred to as a second detection signal S22. The second detection signal S22 has a correspondence with the strength of the component of the rotating magnetic field MF in the direction parallel to the second reference direction D2.

In other respects, the configuration of the angle detection device 1 according to the example embodiment is the same as that of the first example embodiment.

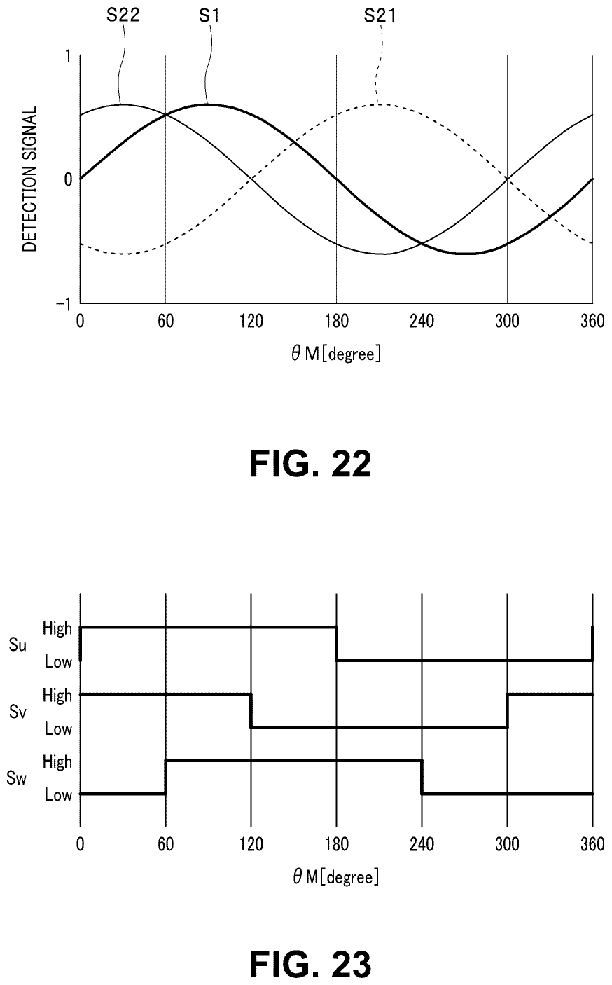

Next, the first detection signal S1, the second detection signals S21 and S22, and the first to third logic signals Su, Sv, and Sw in the example embodiment will be described. FIG. 22 is a waveform chart showing the waveform of each of the first and second detection signals S1, S21, and S22 in the example embodiment. In FIG. 22, the horizontal axis indicates the rotation angle θM of the motor 110, and the vertical axis indicates the magnitude of the signals. The vertical axis is in an arbitrary unit. As shown in FIG. 22, the phase difference between the first detection signal S1 and the second detection signal S22 is 60°.

FIG. 23 is a timing chart showing the first to third logic signals Su, Sv, and Sw in the example embodiment. In the present example embodiment, like the first example embodiment, the first comparator 21 outputs a high-level signal if the rotation angle θM is greater than 0° and less than 180°, and outputs a low-level signal if the rotation angle θM is greater than 180° and less than 360°.

In the example embodiment, the second detection signal S22 is input to the first input port 22a of the second comparator 22. As shown in FIG. 22, the value of the second detection signal S22 is greater than that of the reference voltage (0 on the vertical axis of FIG. 22) if the rotation angle θM is greater than or equal to 0° and less than 120°, or greater than 300° and less than or equal to 360°. The value of the second detection signal S22 is less than the value of the reference voltage (0 on the vertical axis of FIG. 22) if the rotation angle θM is greater than 120° and less than 300°. The second comparator 22 thus outputs a high-level signal if the rotation angle θM is greater than or equal to 0° and less than 120°, or greater than 300° and less than or equal to 360°, and outputs a low-level signal if the rotation angle θM is greater than 120° and less than 300°.

In the example embodiment, the second detection signal S22 is input to the second input port 23b of the third comparator 23. The third comparator 23 compares the value of the first detection signal S1 and that of the second detection signal S22, and outputs the third logic signal Sw. As shown in FIG. 22, the value of the first detection signal S1 is greater than that of the second detection signal S22 if the rotation angle θM is greater than 60° and less than 240°. The value of the first detection signal S1 is less than that of the second detection signal S22 if the rotation angle θM is greater than or equal to 0° and less than 60°, or greater than 240° and less than or equal to 360°. The third comparator 23 thus outputs a high-level signal if the rotation angle θM is greater than 60° and less than 240°, and outputs a low-level signal if the rotation angle θM of the motor 110 is greater than or equal to 0° and less than 60°, or greater than 240° and less than or equal to 360°.

In the example embodiment, when the first to third logic signals Su, Sv, and Sw are at the high level, high level, and low level, respectively, the control circuit 121 of the logic signal generation section 20 determines that the rotation angle θM is in the range of 0° to 60°. When the first to third logic signals Su, Sv, and Sw are at the high level, high level, and high level, respectively, the control circuit 121 determines that the rotation angle θM of the motor 110 is in the range of 60° to 120°. In such a manner, the control circuit 121 detects the rotation angle θM of the motor 110 in units of 60° (every ⅙ turns) based on the combination of the levels of the first to third logic signals Su, Sv, and Sw.

The inverting amplifier 26 may be included in the angle sensor 10 instead of the logic signal generation section 20. In such a case, the second detection signal S22 is output from the second output terminal 10d of the angle sensor 10. The configuration and operation of the logic signal generation section 20 here are the same as in the first example embodiment.

In other respects, the configuration of the angle detection device 1 according to the present embodiment is the same as that of the first or second example embodiment.

### Seventh Example Embodiment

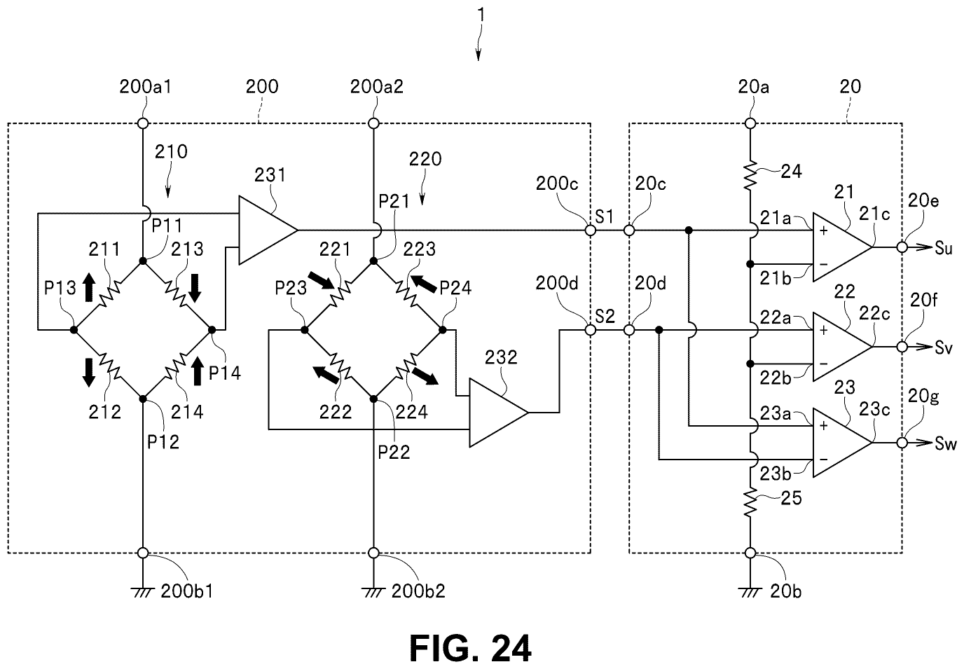

Next, a seventh example embodiment of the technology will be described with reference to FIG. 24. FIG. 24 is a circuit diagram showing a circuit configuration of an angle detection device 1.

The angle detection device 1 according to the example embodiment includes an angle sensor 200 instead of the angle sensor 10 in the first example embodiment. The angle sensor 200 is configured to detect the rotating magnetic field MF and output the first detection signal S1 and the second detection signal S2.

The angle sensor 200 includes power supply terminals 200a1 and 200a2, ground terminals 200b1 and 200b2, a first output terminal 200c, a second output terminal 200d, a first bridge circuit 210, a second bridge circuit 220, a first differential amplifier 231, and a second differential amplifier 232.

The first bridge circuit 210 includes a first resistor section 211, a second resistor section 212, a third resistor section 213, a fourth resistor section 214, and a plurality of MR elements 50 constituting the first to fourth resistor sections 211 to 214.

An end of each of the first and third resistor sections 211 and 213 is connected to a connection point P11. An end of each of the second and fourth resistor sections 212 and 214 is connected to a connection point P12. The other ends of the first and second resistor sections 211 and 212 are connected to a connection point P13. The other ends of the third and fourth resistor sections 213 and 214 are connected to a connection point P14.

The connection point P11 is connected to the power supply terminal 200a1. The connection point P12 is connected to the ground terminal 200b1. A voltage or current of a predetermined magnitude is applied to the power supply terminal 200a1. The ground terminal 200b1 is grounded.

An output port of the first differential amplifier 231 is connected to the first output terminal 200c. The first differential amplifier 231 generates a signal corresponding to a potential difference between the connection points P13 and P14 as a first detection signal S1. The first output terminal 200c outputs the first detection signal S1.

In the example embodiment, the first magnetization of the magnetization pinned layer 52 in each of the plurality of MR elements 50 constituting the first and fourth resistor sections 211 and 214 includes a component in the first reference direction D1 (see FIG. 4). The first magnetization of the magnetization pinned layer 52 in each of the plurality of MR elements 50 constituting the second and third resistor sections 212 and 213 includes a component in the direction opposite to the first reference direction D1. The first detection signal S1 has a correspondence with the strength of the component of the rotating magnetic field MF in a direction parallel to the first reference direction D1.

The second bridge circuit 220 includes a first resistor section 221, a second resistor section 222, a third resistor section 223, a fourth resistor section 224, and the plurality of MR elements 50 constituting the first to fourth resistor sections 221 to 224.

An end of each of the first and third resistor sections 221 and 223 is connected to a connection point P21. An end of each of the second and fourth resistor sections 222 and 224 is connected to a connection point P22. The other ends of the first and second resistor sections 221 and 222 are connected to a connection point P23. The other ends of the third and fourth resistor sections 223 and 224 are connected to a connection point P24.

The connection point P21 is connected to the power supply terminal 200a2. The connection point P22 is connected to the ground terminal 200b2. A voltage or current of a predetermined magnitude is applied to the power supply terminal 200a2. The ground terminal 200b2 is grounded.

An output port of the second differential amplifier 232 is connected to the second output terminal 200d. The second differential amplifier 232 generates a signal corresponding to a potential difference between the connection points P23 and P24 as a second detection signal S2. The second output terminal 200d outputs the second detection signal S2.

In the example embodiment, the first magnetization of the magnetization pinned layer 52 in each of the plurality of MR elements 50 constituting the first and fourth resistor sections 221 and 224 includes a component in the second reference direction D2 (see FIG. 4). The first magnetization of the magnetization pinned layer 52 in each of the plurality of MR elements 50 constituting the second and third resistor sections 222 and 223 includes a component in the direction opposite to the second reference direction D2. The second detection signal S2 has a correspondence with the strength of the component of the rotating magnetic field MF in a direction parallel to the reference direction D2.

The logic signal generation section 20 has the same configuration as in the first example embodiment. The first output terminal 200c of the angle sensor 200 is connected to the first input terminal 20c of the logic signal generation section 20. The second output terminal 200d of the angle sensor 200 is connected to the second input terminal 20d of the logic signal generation section 20.

In other respects, the configuration of the angle detection device 1 according to the example embodiment is the same as that of the first or second example embodiment.

The technology is not limited to the foregoing example embodiments, and various modifications can be made. For example, the third and fourth resistor sections 13 and 14 of the angle sensor 10 may have the same configuration as that of the first and second resistor sections 11 and 12 of the angle sensor 10, including the directions of the first magnetizations of the magnetization pinned layers 52. In such a case, the pair of first and second resistor sections 11 and 12 and the pair of third and fourth resistor sections 13 and 14 are located at respective different positions so that the value of a phase difference between the first detection signal S1 and the second detection signal S2 is not an integer multiple of 90°.

At least a part of the control circuit 121 and the logic signal generation section 20 may be implemented by an ASIC or a microcomputer.

The angle detection device 1 may include an optical angle sensor instead of the angle sensor 10 or 200.

As described above, the angle detection device according to one embodiment of the technology is used for a driving circuit for a motor. The angle detection device according to one embodiment of the technology includes an angle sensor configured to detect a physical quantity that changes periodically in response to a rotation angle of the motor and output a first detection signal and a second detection signal having a phase difference whose value is not an integer multiple of 90°, and a logic signal generation section configured to generate a first logic signal using the first detection signal, generate a second logic signal having a phase different from that of the first logic signal using the second detection signal, and generate a third logic signal having a phase different from those of the first and second logic signals using the first and second detection signals.

In the angle detection device according to one embodiment of the technology, the logic signal generation section may include a first comparator configured to generate the first logic signal, a second comparator configured to generate the second logic signal, and a third comparator configured to generate the third logic signal. The angle sensor may include a first output terminal that outputs the first detection signal and a second output terminal that outputs the second detection signal. Each of the first, second, and third comparators may include a first input port and a second input port. The first output terminal may be connected to the first input port of the first comparator and the first input port of the third comparator. The second output terminal may be connected to the first input port of the second comparator and the second input port of the third comparator.

In the angle detection device according to one embodiment of the technology, the physical quantity may be a magnetic field whose direction rotates in response to a change in the rotation angle. The angle sensor may include a plurality of magnetic detection elements each configured to detect a magnetic field. The plurality of magnetic detection elements may include a plurality of first magnetoresistive elements configured to generate the first detection signal and a plurality of second magnetoresistive elements configured to generate the second detection signal. Each of the plurality of first and second magnetoresistive elements may include a magnetization pinned layer having a first magnetization whose direction is fixed, a free layer having a second magnetization whose direction is variable depending on the magnetic field, and a gap layer located between the magnetization pinned layer and the free layer. A difference between an angle that a first magnetic field direction forms with a first reference direction and an angle that a second magnetic field direction forms with a second reference direction may be an angle that is not an integer multiple of 90°, where the first reference direction is a reference direction for the direction of the first magnetization in each of the plurality of first magnetoresistive elements, the second reference direction is a reference direction for the direction of the first magnetization in each of the plurality of second magnetoresistive elements, the first magnetic field direction is a direction of the magnetic field detected by each of the plurality of first magnetoresistive elements at predetermined timing when the magnetic field changes periodically, and the second magnetic field direction is a direction of the magnetic field detected by each of the plurality of second magnetoresistive elements at the predetermined timing.

If the plurality of magnetic detection elements include the plurality of first magnetoresistive elements and the plurality of second magnetoresistive elements, an angle formed between the first reference direction and the second reference direction may be not an integer multiple of 90°. In such a case, the angle formed between the first reference direction and the second reference direction may be the same as an angle corresponding to the phase difference between the first detection signal and the second detection signal or different from the angle corresponding to the phase difference between the first detection signal and the second detection signal. The angle detection device according to one embodiment of the technology may further include a chip including the plurality of first magnetoresistive elements and the plurality of second magnetoresistive elements.

The angle detection device according to one embodiment of the technology may further include a first chip including the angle sensor and a second chip including the logic signal generation section. One of the first and second chips may be mounted on the other of the first and second chips.

The angle detection device according to one embodiment of the technology may further include a chip including the angle sensor and the logic signal generation section.

A motor device according to one embodiment of the technology includes the angle detection device according to one embodiment of the technology and the motor.

The motor device according to one embodiment of the technology may further include a magnetic field generation section configured to generate a magnetic field whose direction rotates in response to a change in the rotation angle. The physical quantity may be the magnetic field. The angle sensor may be configured to detect the magnetic field generated by the magnetic field generation section.

A logic signal generator according to one embodiment of the technology is configured to generate three logic signals having respective different phases. The logic signal generator according to one embodiment of the technology is configured to obtain a first detection signal and a second detection signal having a phase difference whose value is not an integer multiple of 90°, generate and output a first logic signal using the first detection signal, generate and output a second logic signal having a phase different from that of the first logic signal using the second detection signal, and generate and output a third logic signal having a phase different from those of the first and second logic signals using the first and second detection signals.

Obviously, many modifications and variations of the technology are possible in the light of the above teachings. Thus, it is to be understood that, within the scope of the appended claims and equivalents thereof, the technology may be practiced in other example embodiments than the foregoing example embodiments.

What is claimed is:

1. An angle detection device used for a driving circuit for a motor, comprising:
an angle sensor configured to detect a physical quantity that changes periodically in response to a rotation angle of the motor and output a first detection signal and a second detection signal having a phase difference whose value is not an integer multiple of 90°; and
a logic signal generation section configured to generate a first logic signal using the first detection signal, generate a second logic signal having a phase different from that of the first logic signal using the second detection signal, and generate a third logic signal having a phase different from those of the first and second logic signals using the first and second detection signals.

2. The angle detection device according to claim 1, wherein the logic signal generation section includes a first comparator configured to generate the first logic signal, a second comparator configured to generate the second logic signal, and a third comparator configured to generate the third logic signal.

3. The angle detection device according to claim 2, wherein:
the angle sensor includes a first output terminal that outputs the first detection signal and a second output terminal that outputs the second detection signal;
each of the first, second, and third comparators includes a first input port and a second input port;
the first output terminal is connected to the first input port of the first comparator and the first input port of the third comparator; and
the second output terminal is connected to the first input port of the second comparator and the second input port of the third comparator.

4. The angle detection device according to claim 1, wherein:
the physical quantity is a magnetic field whose direction rotates in response to a change in the rotation angle; and
the angle sensor includes a plurality of magnetic detection elements each configured to detect the magnetic field.

5. The angle detection device according to claim 4, wherein:
the plurality of magnetic detection elements include a plurality of first magnetoresistive elements configured to generate the first detection signal and a plurality of second magnetoresistive elements configured to generate the second detection signal;
each of the plurality of first and second magnetoresistive elements includes a magnetization pinned layer having a first magnetization whose direction is fixed, a free layer having a second magnetization whose direction is variable depending on the magnetic field, and a gap layer located between the magnetization pinned layer and the free layer; and
a difference between an angle that a first magnetic field direction forms with a first reference direction and an angle that a second magnetic field direction forms with a second reference direction is an angle that is not an integer multiple of 90°, where the first reference direction is a reference direction for the direction of the first magnetization in each of the plurality of first magnetoresistive elements, the second reference direction is a reference direction for the direction of the first magnetization in each of the plurality of second magnetoresistive elements, the first magnetic field direction is the direction of the magnetic field detected by each of the plurality of first magnetoresistive elements at a predetermined timing when the magnetic field changes periodically, and the second magnetic field direction is the direction of the magnetic field detected by each of the plurality of second magnetoresistive elements at the predetermined timing.

6. The angle detection device according to claim 5, wherein an angle formed between the first reference direction and the second reference direction is not an integer multiple of 90°.

7. The angle detection device according to claim 5, wherein an angle formed between the first reference direction and the second reference direction is same as an angle corresponding to the phase difference between the first detection signal and the second detection signal.

8. The angle detection device according to claim 5, wherein an angle formed between the first reference direction and the second reference direction is different from an angle corresponding to the phase difference between the first detection signal and the second detection signal.

9. The angle detection device according to claim 5, further comprising a chip including the plurality of first magnetoresistive elements and the plurality of second magnetoresistive elements.

10. The angle detection device according to claim 1, further comprising:
a first chip including the angle sensor; and
a second chip including the logic signal generation section.

11. The angle detection device according to claim 10, wherein one of the first and second chips is mounted on another of the first and second chips.

12. The angle detection device according to claim 1, further comprising a chip including the angle sensor and the logic signal generation section.

13. A motor device comprising:
the angle detection device according to claim 1; and
the motor.

14. The motor device according to claim 13, further comprising a magnetic field generation section configured to generate a magnetic field whose direction rotates in response to a change in the rotation angle, wherein:
the physical quantity is the magnetic field; and
the angle sensor is configured to detect the magnetic field generated by the magnetic field generation section.

15. A logic signal generator configured to generate three logic signals having respective different phases,
the logic signal generator is configured to
obtain a first detection signal and a second detection signal having a phase difference whose value is not an integer multiple of 90°,
generate and output a first logic signal using the first detection signal,
generate and output a second logic signal having a phase different from that of the first logic signal using the second detection signal, and
generate and output a third logic signal having a phase different from those of the first and second logic signals using the first and second detection signals.
